(19) United States
(12) Patent Application Publication
(10) Pub. No.: US 2002/0122376 A1
(43) Pub. Date: Sep. 5, 2002

(54) Near field recording/reproducing optical head

(75) Inventor: Ki-Bong Song, Gyeonggi-do (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD, Suwon-City (KR)

(21) Appl. No.: 09/986,456

(22) Filed: Nov. 8, 2001

(30) Foreign Application Priority Data
Mar. 3, 2001 (KR) 2001-5254

(51) Int. Cl. G11B 7/135

(52) U.S. Cl. 369/112.27; 369/300

(57) ABSTRACT

A near field recording/reproducing optical head including a light unit which radiates light having a predetermined wavelength at a recording medium and detects light reflected from a recording side of the recording medium, and an optical waveguide probe installed at a slider which is raised above the recording medium by dynamic air pressure attendant upon the rotation of the recording medium. The optical waveguide probe includes an optical waveguide installed at the slider such that its one end faces the recording medium, and a self focusing layer formed of a nonlinear optical material, of which the refractive index changes according to the intensity of an incident light beam, at the end of the optical waveguide facing the recording medium. The optical waveguide transmits incident light from the light unit to the recording medium and transmits incident light reflected from the recording medium to the light unit. The self focusing layer focuses a light beam incident from the optical waveguide, thereby forming a light spot on the recording medium. Since the near field recording/reproducing optical head includes the self focusing layer formed of a nonlinear optical material at one end of the optical waveguide, it produces a very small beam having a size of a full wavelength or less overcoming the limit of diffraction, thereby performing recording at a high recording density even with light having a wavelength in a range between the red region and the near infrared region and considerably alleviating difficulty in manufacture and a degradation problem. In addition, since the self focusing layer has a high transmittance, recording can be performed with light having less power than in an existing near field recording optical head employing an optical fiber probe. Moreover, the self focusing layer has a small absorption coefficient so that a heating problem can be prevented.

### CROSS-REFERENCE TO RELATED APPLICATIONS

This application claims the benefit of Korean Patent Application No. 2001-5254 filed on Feb. 3, 2001, in the Korean Industrial Property Office, the disclosure of which is incorporated herein by reference.

### BACKGROUND OF THE INVENTION

1. Field of the Invention

The present invention relates to a near field recording/reproducing optical head, and more particularly, to a near field recording/reproducing optical head having a structure in which an optical waveguide probe is mounted on a slider.

2. Description of the Related Art

In order to increase information storage capacity per unit area, development of optical recording and reproducing apparatuses has tended toward shortening of the wavelength of a recording light source and increasing of the numerical aperture of an objective lens. In other words, there is the intention of employing a light source having a blue wavelength and an objective lens having a numerical aperture no less than 0.75. An example is employing an objective lens with a numerical aperture of 0.85 for use with an optical recording and reproducing apparatus used with recording media such as next generation DVDs referred to as high-definition DVD (HD-DVD), instead of employing a light source having a wavelength in the infrared and an objective lens having a numerical aperture of 0.45, as are used for CDs, or instead of employing a light source having a wavelength in the optical red region and an objective lens having a numerical aperture of 0.6, as are used for DVDs.

However, taking into account mass production, it is difficult to manufacture an objective lens having a numerical aperture of, for example, 0.65 or more, with a single lens. Therefore, methods realizing a high numerical aperture of, for example, 0.75 or more, by making a compound objective lens out of a plurality of lenses have been proposed. However, using two or more lenses to realize a compound objective lens having a high numerical aperture results in a complex structure and difficulty with optical arrangement.

To overcome these problems, a near field recording technique has been proposed. Generally, the near field recording technique indicates a technique of performing data recording or reproduction in a state in which an optical element is disposed to be near a recording medium, such as an optical disc, so that the gap therebetween is about 20-300 nm.

As is widely known, such a near field recording technique employs a driving device using a swing arm. According to a near field recording technique, a light focusing unit is mounted at a slider which is installed at a swing arm to be elastically biased toward a recording medium, the light focusing unit is raised together with the slider by dynamic air pressure due to the rotation of the recording medium so as to be near the recording medium . Thus, a light spot is formed on the recording surface of the recording medium within a near field, and the location of the light spot on the recording medium is determined by moving the swing arm around a hinge point, thereby recording or reproducing an information signal in a near field.

A conventional near field recording optical head includes a solid immersion lens (SIL) 10, as shown in FIG. 1, a solid immersion mirror (SIM) 20, as shown in FIG. 2, or a probe being pointed at the end, as shown in FIG. 3. Each of these conventional units shown in FIGS. 1 through 3 acts as a light focusing unit mounted at a slider, and forms a very small light spot (usually having a diameter smaller than the wavelength of light) overcoming the limit of diffraction to perform recording.

Referring to FIG. 1, a conventional near field recording optical head employing an SIL 10 also includes a condensing lens 15 primarily condensing incident light. The SIL 10 secondarily condenses the light condensed by the condensing lens 15 on a recording medium 1. The condensing lens 15 and the SIL 10 are mounted at a slider (not shown). Since a beam which has been primarily condensed by the condensing lens 15 is incident on the SIL 10, an effective numerical aperture is 1.0 or more at the SIL 10, thereby overcoming the limit of diffraction and focusing the beam within a near field. Here, the gap G between the SIL 10 and the recording medium 1 is within 100 nm.

Referring to FIG. 2, an SIM 20 used in a conventional near field recording optical head includes a first transmitting surface 21 which is disposed on an optical axis from which incident light diverges, a second transmitting surface 23 facing the first transmitting surface 21, a first reflective surface 25 which is disposed around the second transmitting surface 23 to reflect incident light which has diverged from the first transmitting surface 21, and a second reflective surface 27 which is disposed around the first transmitting surface 21 to reflect and condense light incident from the first reflective surface 25 toward the second transmitting surface 23. The SIM 20 is mounted at a slider (not shown). Because parallel light incident on the first transmitting surface 21 is reflected by the first and second reflective surfaces 25 and 27, and then focused within a near field through the second transmitting surface 23, the SIM 20 has a high effective numerical aperture. As in a conventional near field recording optical head employing the SIL 10 of FIG. 1, the gap G between the SIM 20 and the recording medium 1 is within 100 nm.

Referring to FIG. 3, a conventional near field recording optical head employing a probe has a structure in which an optical fiber probe 30 pointed at the end is attached to a slider 5. The optical fiber probe 30 is formed by sharpening one end of an optical fiber and coating the outer surface of the sharpened portion with a metal 35. The diameter of the end of the optical fiber probe 30, that is, the diameter of the end of a core 31, is several hundreds of nanometers (preferably 300 nm or less). Here, instead of the optical fiber probe 30, a small aperture may be formed. Reference numeral 33 denotes a clad layer of an optical fiber.

In conventional near field recording optical heads, as shown in FIGS. 1 through 3, the SIL 10, the SIM 20 and the optical fiber probe 30 are separated from the recording medium 1 by a gap G of about 20-300 nm, which is smaller than the wavelength of light used during the rotation of the recording medium 1, due to the rotation of the recording medium 1, so that incident light can be focused on a near field overcoming the limit of diffraction. Therefore, a light spot having a desired size can be formed.

However, conventional near field recording optical heads as shown in FIGS. 1 through 3 have the following problems and difficulty during manufacturing. For an optical head employing the SIL 10 shown in FIG. 1, it is difficult to combine the condensing lens 15 with the SIL 10. In addition, since the SIL 10 is formed of semiconductor material, manufacturing the SIL 10 is not simple. Moreover, since the SIL 10, formed of the semiconductor material, is degraded due to heating from high density light focusing, it is difficult to maintain the SIL 10 near the recording medium 1.

In a conventional optical head employing the SIM 20 shown in FIG. 2, the SIM 20 is small enough to be used for near field recording. However, it is not easy to perform coating on the small SIM 20 in order to form the first and second reflective surfaces 25 and 27.

The optical fiber probe 30 shown in FIG. 3 is manufactured more easily than the SIL 10 and the SIM 20. However, in the optical fiber probe 30 with a sharp point having a diameter of several hundreds of nanometers, the output efficiency, i.e., the ratio of the amount of light output through one end of the probe 30 to the amount of light incident on the other end thereof, is no greater than 10⁻⁴. Accordingly, it is impossible to use an optical head employing the optical fiber probe 30 for recording. Moreover, since the diameter of the sharp end of the optical fiber probe 30, which is several hundreds of nanometers (preferably 300 nm or less), is smaller than the wavelength of light used, when the intensity of incident light is increased for the purpose of recording, the point of the optical fiber probe 30 heats up and melts.

### SUMMARY OF THE INVENTION

Accordingly, it is an object of the present invention to provide a near field recording/reproducing optical head employing an optical waveguide probe which can be manufactured more easily than a solid immersion mirror and which has an improved structure in which a heating problem is prevented from occurring at the probe.

Additional objects and advantages of the invention will be set forth in part in the description which follows and, in part, will be obvious from the description, or may be learned by practice of the invention.

The foregoing objects of the present invention are achieved by providing a near field recording/reproducing optical head including a light unit which radiates light having a predetermined wavelength at a recording medium and detects light reflected from a recording side of the recording medium, and an optical waveguide probe installed at a slider which is raised above the recording medium by dynamic air pressure due to rotation of the recording medium. The optical waveguide probe includes an optical waveguide installed at the slider such that its one end faces the recording medium, and a self focusing layer formed of a nonlinear optical material, of which the refractive index changes according to the intensity of an incident light beam, formed at the end of the optical waveguide facing the recording medium. The optical waveguide transmits incident light from the light unit to the recording medium and transmits incident light reflected from the recording medium to the light unit. The self focusing layer focuses a light beam incident from the optical waveguide, thereby forming a light spot on the recording medium.

Here, the near field recording/reproducing optical head may further include a mask between the self focusing layer and the recording medium. The mask includes a quadrilateral or circular light transmitting portion having a width smaller than the width of a light beam incident from the self focusing layer. The self focusing layer can be formed of a material selected from the group consisting of As₂S₃, oxide and material with a GaAs quantum dot.

### BRIEF DESCRIPTION OF THE DRAWINGS

These and other objects and advantages of the present invention will become apparent and more readily appreciated from the following description of the embodiments, taken in conjunction with the accompany drawings of which:

FIG. 1 is schematic diagram of a conventional near field recording optical head employing a solid immersion lens;

FIG. 2 is a schematic diagram of a conventional near field recording optical head employing a solid immersion mirror;

FIG. 3 is a schematic diagram of a conventional near field recording optical head employing a probe;

FIG. 4 is a schematic diagram of a near field recording/reproducing optical head according to a first embodiment of the present invention;

FIG. 5 is a diagram of an example of the optical structure of the light unit of FIG. 4;

FIG. 6 illustrates focusing of an incident light beam at the self focusing layer of FIG. 4;

FIG. 7 is a schematic diagram of the main portion of a near field recording/reproducing optical head according to a second embodiment of the present invention; and

FIG. 8 shows the size of a light beam passing the self focusing layer of FIG. 7 compared to the size of a light beam passing the mask of FIG. 7.

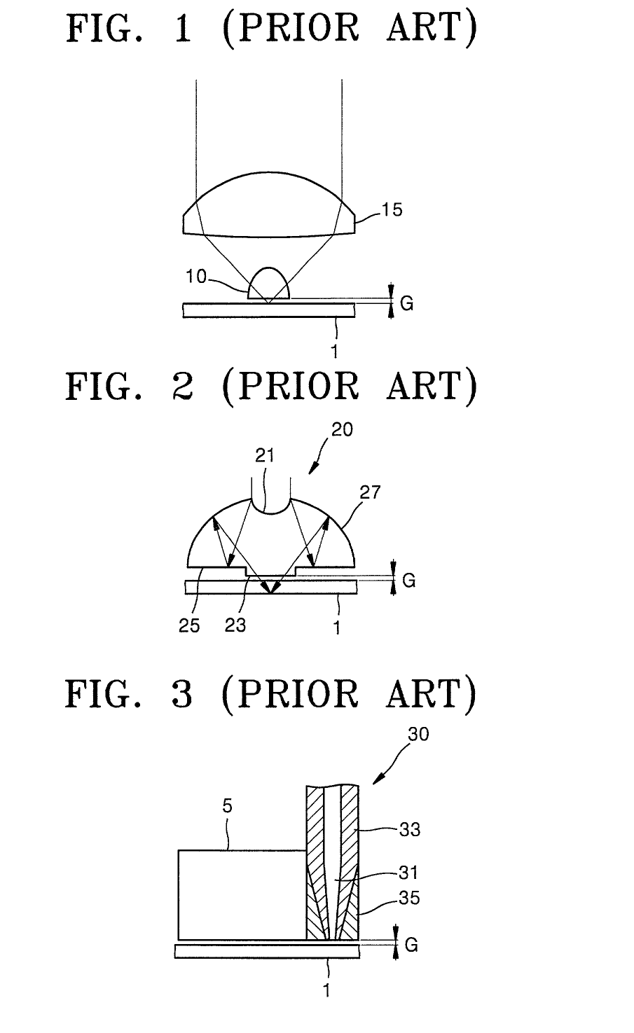

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

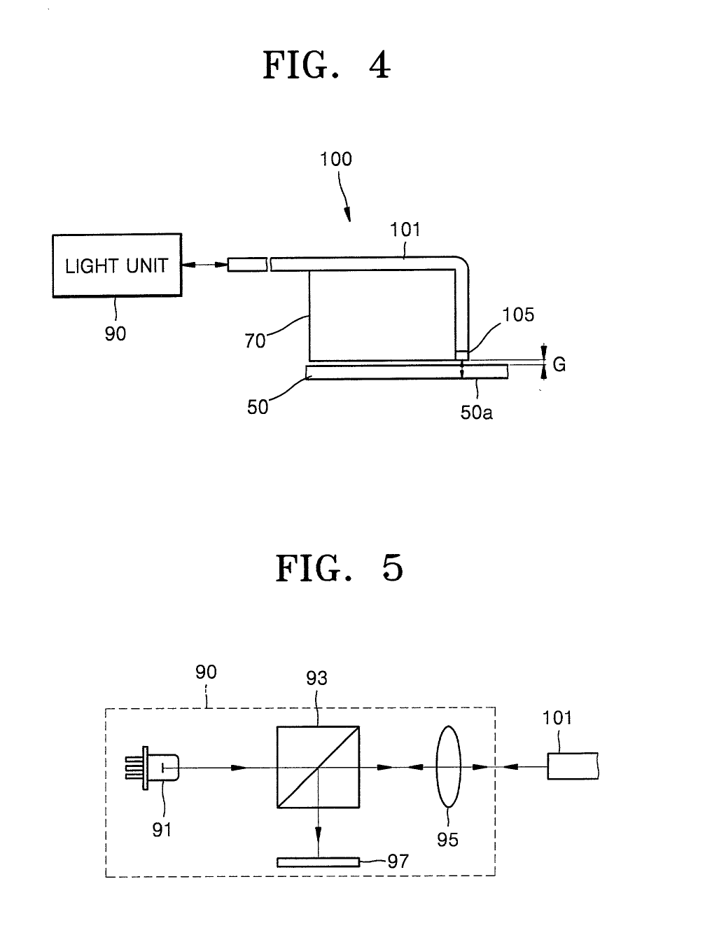

Referring to FIG. 4, a near field recording/reproducing optical head according to an embodiment of the present invention includes a light unit 90 radiating light having a predetermined wavelength at a recording medium 50 and detecting light reflected from a recording surface 50a of the recording medium 50 so as to detect an information reproduction signal and/or an error signal. Also provided is an optical waveguide probe 100 installed at a slider 70, which is raised above the recording medium 50 by dynamic air pressure from the rotation of the recording medium 50.

As shown in FIG. 5, the light unit 90 includes a light source 91 emitting light with a predetermined wavelength, a condensing lens 95 condensing the light emitted from the light source 91 on an optical fiber 101 of the optical waveguide probe 100, and a beam splitter 93 disposed between the light source 91 and the condensing lens 95 to change the path of incident light. Also provided as part of the light unit 90 is a photodetector 97 detecting light which has been reflected from the recording medium 50 and then sequentially passed through the optical fiber 101 of the optical waveguide probe 100, the condensing lens 95 and the beam splitter 93, so as to detect an information reproduction signal and/or an error signal. FIG. 5 shows only an example of the light unit 90 used in the present invention, however, the light unit 90 of an optical head according to the present invention is not restricted to the optical structure shown in FIG. 5.

Referring back to FIG. 4, the optical waveguide probe 100 includes the optical fiber 101 which is installed at the slider 70 such that one end of the optical fiber 101 faces the recording medium 50. The optical fiber 101 transmits incident light from the light unit 90 to the recording medium 50, and also transmits incident light reflected from the recording medium 50 back to the light unit 90. The one end of the optical fiber 101 facing the recording medium 50 is coated with a self focusing layer 105.

For the optical fiber 101, a single-mode optical fiber or multi-mode optical fiber suitable for 650 nm (or 633 nm) light may be used. Light transmitted from the light unit 90 through the optical fiber 101 is focused by the self focusing layer 105, thereby forming a light spot on the recording surface 50a of the recording medium 50. Here, for an optical waveguide used in the optical waveguide probe 100 according to the present invention, not only the optical fiber 101 may be used, but any type of optical waveguide capable of transmitting light can be used.

The self focusing layer 105 of this embodiment is formed of a nonlinear optical material, for example, As₂S₃, oxide or material with a GaAs quantum dot, of which the refractive index varies with the intensity of an incident light beam and of which the absorption coefficient with respect to the wavelength of incident light is small. The As₂S₃, oxide or material with a GaAs quantum dot is a nonlinear optical material which has a small absorption coefficient, and of which the refractive index varies with the intensity of an incident light beam with respect to light having a wavelength in the range between the optical red region and the near infrared region. The As₂S₃, oxide or material with a GaAs quantum dot also has a refractive index which greatly varies with the intensity of an incident light, and has a large third-order nonlinear coefficient. Here, for the oxide, an oxide such as Al₂O₃, of which a thin film can be formed, can be used. The material with a GaAs quantum dot is a material in which a GaAs quantum dot is formed within a base material, for example, AlGaAs. Here, it is preferable that the size of a dot is within 20 nm.

When the basic refractivity component of the self focusing layer 105 is represented by n₀, a refractivity component changing according to the intensity of an incident light beam is represented by n′, and the intensity of the incident light beam is represented by I, the refractive index n of the self focusing layer 105 can be expressed by Equation (1).

n=n₀+n′l (1)

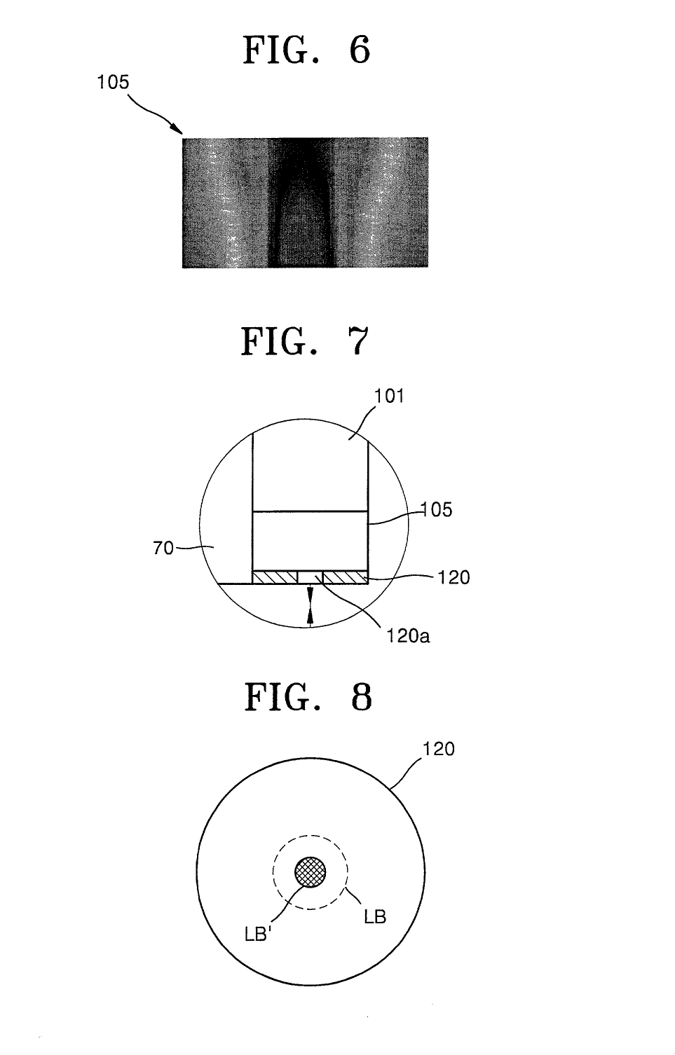

A light beam which is transmitted from the light unit 90 through the optical fiber 101 essentially has a Gaussian intensity distribution so that a portion of the self focusing layer 105 nearer to an optical axis has a larger refractive index with respect to the incident light beam and a portion thereof farther from the optical axis has a smaller refractive index with respect to the incident light beam. Accordingly, the incident light beam is condensed through the self focusing layer 105, as shown in FIG. 6. Here, the diameter of the condensed incident light beam can be reduced to a maximum half-wavelength or less according to the thickness of the self focusing layer 105. The size of the reduced light beam is adjusted according to the intensity of the incident light beam and the thickness of the self focusing layer 105. Since a material constituting the self focusing layer 105 has a very small absorption coefficient with respect to light having a wavelength in a range, for example, between 633 nm and 780 nm, the self focusing layer 105 has a high condensing ratio and a high transmittance.

According to a test, when a light beam having light power of 2.2 mW and a wavelength of 633 nm was incident on an optical waveguide probe having a self focusing layer which was formed by coating the end of an optical fiber with As₂S₃ to a thickness of 1.7 μm, the size of a light beam was reduced by 40% through the self focusing layer.

Therefore, a near field recording/reproducing optical head according to the present invention has high optical efficiency so that it can perform recording with small light output power. In addition, since a near field recording/reproducing optical head according to the present invention has a high condensing ratio, it can provide recording capacity of 15 GB or more even with red light.

To provide even larger recording capacity, a near field recording/reproducing optical head according to the present invention can also include a mask 120 between the self focusing layer 105 and the recording medium 50, as shown in FIG. 7. The mask 120 has a circular light transmitting portion 120a, which has a diameter smaller than a light beam radiating from the self focusing layer 105, at its center. The mask 120 can be coated on the surface of the self focusing layer 105 facing the recording medium 50. As shown in FIG. 8, the mask 120 restricts the size of a light beam LB′ to the size of the light transmitting portion 120a so that the size of the light beam LB′ passing the mask 120 is smaller than that of a light beam LB passing the self focusing layer 105. Therefore, the recording capacity of a near field recording/reproducing optical head according to the present invention can be increased. Alternatively, the light transmitting portion 120a of the mask 120 may be formed to have a quadrilateral shape having a smaller width than the diameter of a light beam radiating from the self focusing layer 105. Here, the circular or quadrilateral light transmitting portion 120a can be formed of a transparent material or can be realized as a light transmitting hole.

In near field recording/reproducing optical heads according to the above embodiments of the present invention, one side of the optical fiber probe 100, including the self focusing layer 105 or the self focusing layer 105 and the mask 120, is disposed on the slider 70, which is installed at a swing arm to be elastically biased toward the recording medium 50 so that an information signal can be recorded to or reproduced from the recording surface 50a of the recording medium 50 according to swing arm driving mechanism.

As described above, since a near field recording/reproducing optical head according to the present invention includes a self focusing layer formed of a nonlinear optical material at one end of an optical waveguide, it produces a very small beam having a size of a full wavelength or less overcoming the limit of diffraction, thereby performing recording at a high recording density even with light having a wavelength in a range between the red region, and the near infrared region and considerably alleviating difficulty in manufacture and a degradation problem. In addition, since the self focusing layer has a high transmittance, a near field recording/reproducing optical head according to the present invention can perform recording with light having less power than in a conventional near field recording optical head employing an optical fiber probe. Moreover, the self focusing layer has a small absorption coefficient so that a heating problem can be prevented.

Although preferred embodiments of the present invention have been shown and described, it will be appreciated by those skilled in the art that changes may be made in these embodiments without department from the principle and spirit of the invention, the scope of which is defined in the appended claims and their equivalents.

What is claimed is:

1. A near field recording/reproducing optical head for use with a recording medium, comprising:
a light unit which radiates light having a predetermined wavelength at the recording medium and detects the light reflected from a recording surface of the recording medium; and
a slider which is raised above the recording medium by dynamic air pressure attendant upon the rotation of the recording medium, the slider comprising an optical waveguide probe which comprises:
an optical waveguide installed at the slider and having an end facing the recording medium, the optical waveguide transmitting the light from the light unit to the recording medium and transmitting the light reflected from the recording medium to the light unit; and
a self focusing layer formed of a nonlinear optical material, of which the refractive index changes according to an intensity of an incident light beam, at the end of the optical waveguide facing the recording medium, the self focusing layer condensing the light incident from the optical waveguide, to form a light spot on the recording medium.

2. The near field recording/reproducing optical head of claim 1, further comprising a mask between the self focusing layer and the recording medium, the mask comprising a quadrilateral or circular light transmitting portion having a width smaller than a width of the light incident from the self focusing layer.

3. The near field recording/reproducing optical head of claim 2, wherein the self focusing layer is formed of a material selected from the group consisting of As₂S₃, oxide and material with a GaAs quantum dot.

4. The near field recording/reproducing optical head of claim 3, wherein the optical waveguide comprises an optical fiber.

5. The near field recording/reproducing optical head of claim 1, wherein the self focusing layer is formed of a material selected from the group consisting of As₂S₃, oxide and material with a GaAs quantum dot.

6. The near field recording/reproducing optical head of claim 5, wherein the optical waveguide is formed of an optical fiber.

7. The near field recording/reproducing optical head of claim 2, wherein the optical waveguide is formed of an optical fiber.

8. The near field recording/reproducing optical head of claim 1, wherein the optical waveguide is formed of an optical fiber.

9. The near-field recording/reproducing optical head of claim 1, wherein the optical waveguide is formed of a single-mode or multi-mode optical fiber.

10. The near-field recording/reproducing optical head of claim 1, wherein the optical waveguide is an optical fiber having a first portion adjacent to the light unit extending in a first direction parallel to a surface of the recording medium and a second portion adjacent to the self focusing layer extending in a second direction parallel to the first direction.

11. The near-field recording/reproducing optical head of claim 1, wherein a refractive index n of the self focusing layer is
n=n₀+n′l;
wherein a basic refractivity component is represented by n₀, a refractivity component changing according to the intensity of the incident light beam is represented by n′, and the intensity of the incident light beam is represented by I.

12. The near-field recording/reproducing optical head of claim 1, wherein a region of the self focusing layer nearer to an optical axis thereof has a larger refractive index than that of a region farther from the optical axis.

13. The near field recording/reproducing optical head of claim 1, further comprising a mask between the self focusing layer and the recording medium, the mask comprising a light transmitting portion having a width smaller than a width of the light incident from the self focusing layer.

14. The near field recording/reproducing optical head of claim 1, wherein the light transmitting portion is a transparent material.

15. The near field recording/reproducing optical head of claim 1, wherein the light transmitting portion is a light transmitting hole.

16. The near field recording/reproducing optical head of claim 1, wherein the self focusing layer comprises a nonlinear optical material.

17. A near-field recording/reproducing optical head for use with a recording medium, comprising:
a light unit radiating and detecting light of a predetermined wavelength to and from the recording medium;
a slider;
an optical waveguide positioned at said slider, a first end of the optical waveguide transmitting the radiated light from said light unit to a second end of the optical waveguide and toward the recording medium;
a self focusing layer of a nonlinear optical material formed at said second end of the optical probe with a refractive index changing according to the intensity of the radiated light received from said light unit, said self focusing layer condensing the radiated light to form a spot on the recording medium.

18. The near-field recording/reproducing optical head according to claim 17, further comprising a mask between said self focusing layer and the recording medium.

19. The near-field recording/reproducing optical head according to claim 18, wherein the mask is coated on a surface of said self focusing layer facing the recording medium.

20. A near-field recording/reproducing optical head for use with a recording medium, comprising:
a light unit radiating and detecting light of a predetermined wavelength to and from the recording medium;
an optical waveguide having a first surface to receive the radiated light and a second surface to receive the light from the recording medium, the optical waveguide transmitting the radiated light and the light from the recording medium between the first and second ends; and
a self focusing layer of a nonlinear optical material formed at the second surface of the optical waveguide, to condense the radiated light to form a spot on the recording medium.
